(19) United States
(12) Patent Application Publication
(10) Pub. No.: US 2007/0246108 A1
(43) Pub. Date: Oct. 25, 2007

(54) Quick-disconnect with pressure relief and a locking mechanism

(75) Inventor: Timothy J. Conway, Huntington Beach, CA (US)

Correspondence Address: LEONARD TACHNER, A PROFESSIONAL LAW;CORPORATION, 17961 SKY PARK CIRCLE, SUITE 38-E, IRVINE, CA, 92614, US

(73) Assignee: Preece Incorporated

(21) Appl. No.: 11/406,917

(22) Filed: Apr. 19, 2006

(51) Int. Cl. F16L 37/36

(52) U.S. Cl. 137/614.06

(57) ABSTRACT

A quick-disconnect, the nipple portion of which has a pressure relief path and a coupler portion of which has a safety lock. The nipple portion is provided with a spring-loaded sleeve which covers the relief flow path when not engaged. The sleeve is hand driven against the spring load to expose the flow relief passage. Any pressure in the quick-disconnect is then discharged to atmosphere. The coupler portion incorporates a piston that is pressure activated to block the motion of a disconnecting sleeve. The piston is moved to the unlocked position by a wave spring when the pressure is removed. These features are packaged in a small volume for use in systems where space is limited. The quick-disconnect is designed and fabricated with materials that can withstand a proof pressure of 20,000 PSI. Such capabilities are especially useful in aircraft systems with a supply pressure of up to 5,000 PSI. The pressure relief assures the quick-disconnect can be relieved of any residual pressure up to 5,000 PSI before it is uncoupled and the lock assures that it can not be uncoupled without pressure relief.

### BACKGROUND OF THE INVENTION

1. Field of the Invention

The present invention relates generally to quick-disconnects and more specifically to a quick-disconnect having a spring-loaded sleeve that allows pressure relief and a pressure activating locking piston in a small envelope for high-pressure systems.

2. Background Art

Fluid flow quick-disconnects are well-known devices commonly used to interconnect one flexible pipe or hose to another flexible pipe or hose for transferring fluids. Virtually all quick-disconnects consist of a mating pair of male and female annular connectors referred to as a nipple and a coupler. Quick-disconnects allow expedient connection and disconnection of such hoses or pipes by a simple mechanical release mechanism. When the quick-disconnect is separated, each component provides a sealing feature designed to allow little or no leakage of the fluid.

Each member of the quick-disconnect is designed to connect with the corresponding pipe or hose carrying the fluid and to mate with each other so the respective pipes or hoses can be interconnected. Typically the nipple portion comprises a spring-loaded poppet and the coupler a stationary stem. When the nipple and coupler are mated, the coupler stem engages the nipple poppet, causing the poppet to push open and allow flow around the poppet. In addition, the nipple slides into the coupler body depressing a spring-loaded coupler poppet which allows flow through the coupler. Once the quick-disconnect is engaged, there are a number of ways to secure the nipple and coupler to one another so inadvertent separation and interruption of flow will not occur. The present invention uses a locking mechanism comprised of a novel pressure activated lock piston. In high pressure applications disconnecting the quick-disconnect while under pressure may be hazardous. By using the system pressure to activate the lock, disconnecting while under pressure is virtually impossible.

When a nipple and coupler are connected and attached to pipes or hoses with system pressure from a source such as a pump, after removing power to the pressure source and thus removing pressure from the system, it is likely that residual pressure may reside in the system. In high-pressure systems that residual pressure may have enough energy to cause damage if the quick-disconnect is disengaged. The lock will prevent the disengagement, but there is a need to remove the residual pressure. The present design uses a novel pressure relief in the form of a spring-loaded sleeve and seals.

There is a need for a quick-disconnect for use in limited space applications and with a high-pressure system. The present invention connects small sized pipes or hoses with internal pressures that call for a 20,000 PSI burst test. The present invention incorporates components that are small in size but configured to withstand the high pressure.

The most relevant prior art in regard to quick disconnects for operation with high pressure and pressure relief and which is known to the applicant is disclosed in issued U.S. Pat. No. 5,215,222. This patent discloses a quick disconnect apparatus in which the male coupling element in its uncoupled state will automatically react to excess fluid pressure by increasing its internal volume and, if necessary, permitting some fluid leakage to relieve pressure. However, this connector does not provide for pressure relief in the coupled state and does not provide any locking mechanism to prevent de-coupling under a high-pressure condition.

### SUMMARY OF THE INVENTION

The present invention uses a locking mechanism comprised of a novel pressure activated lock piston. In high pressure applications disconnecting the quick-disconnect while under pressure may be hazardous. By using the system pressure to activate the lock, disconnecting while under pressure is virtually impossible. The lock will prevent the disengagement, but there is a need to remove the residual pressure. The present design uses a novel pressure relief in the form of a spring-loaded sleeve and seals. The present invention connects pipes or hoses with internal pressures that call for a 20,000 PSI burst test. The present invention incorporates components that are small in size but configured to withstand the high pressure.

The present invention comprises a push to connect quick-disconnect having a spring-loaded pressure relief valve for relieving residual pressure in the system and a pressure activated piston lock which prevents the quick-disconnect from being disconnected while under pressure. The result is an improved coupler and nipple design.

The quick-disconnect of the present invention has the novel feature of withstanding up to 20,000 pounds per square inch of burst pressure in a package that is in an envelope that is ideal for small volumes, such as an aerospace application. The body design for both the nipple and coupler unitize design parameters that will withstand the high pressure. O-ring grooves have been designed with added material in the correct proportions to disallow deflections that would force the o-rings and backup rings out of the grooves, which would cause excessive leakage. The grooves in the nipple body and holes in the coupler that house moveable balls used to hold the coupler and nipple in the connected position, have been designed to withstand the bearing stresses associated with high pressure.

It is therefore the principal object of the present invention to provide a novel push to connect quick-disconnect that allows locking of the quick-disconnect to prevent unsafe disconnection in a high-pressure condition.

It is an additional object of the present invention to allow relief of any residual pressure that would prevent the locked piston from unlocking. The relief in the nipple portion of the quick-disconnect allows the bleeding of residual pressure.

It is still an additional object of the present invention to meet the need for a high-pressure quick-disconnect in a package that is usable in a small volume.

### BRIEF DESCRIPTION OF THE DRAWINGS

The aforementioned objects and advantages of the present invention, as well as additional objects and advantages will be fully understood hereinafter as a result of a preferred embodiment of the invention when taken in conjunction with the following drawing in which:

FIG. 1 is a cross-sectional view of the quick-disconnect of the present invention showing the nipple and coupler in the connected position;

FIG. 2 is a cross-sectional view of the nipple portion of the quick-disconnect of the present invention showing the pressure relief components;

FIG. 3 is a cross-sectional view of the coupler portion of the quick-disconnect of the present invention showing the lock components;

FIG. 4 is a cross-sectional view similar to FIG. 1, but showing the pressure relief sleeve moved to the open position, with the flow path through the nipple body and sleeve identified and the bias wave spring in the compressed position;

FIG. 5 is a cross-sectional view similar to FIG. 1, but showing the lock piston moved to the locked position and engaged with the couple/decouple sleeve, locking it in place with the bias wave spring in the compressed position; and

FIG. 6 is a cross-sectional view similar to FIG. 1, but showing the couple/decouple sleeve moved to the uncouple position, the lock piston disengaged and the couple/decouple balls moved out of the groove in the nipple.

### DETAILED DESCRIPTION OF PREFERRED EMBODIMENTS

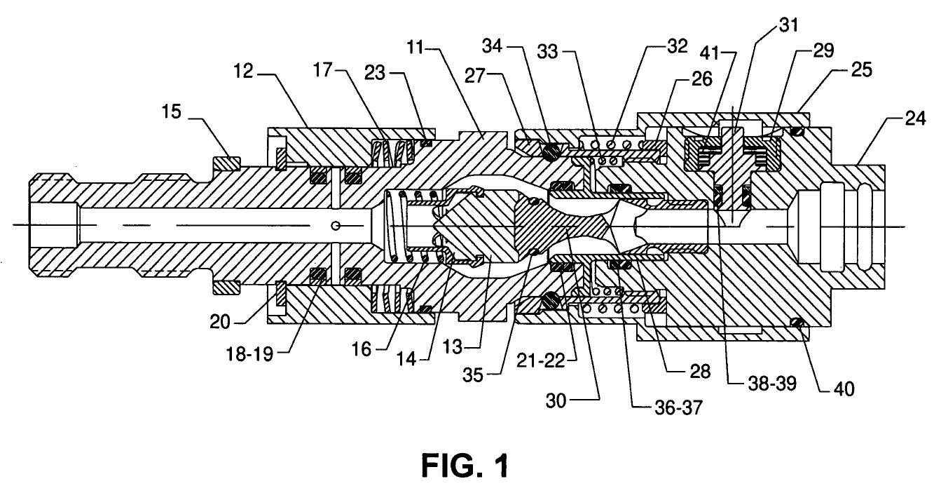

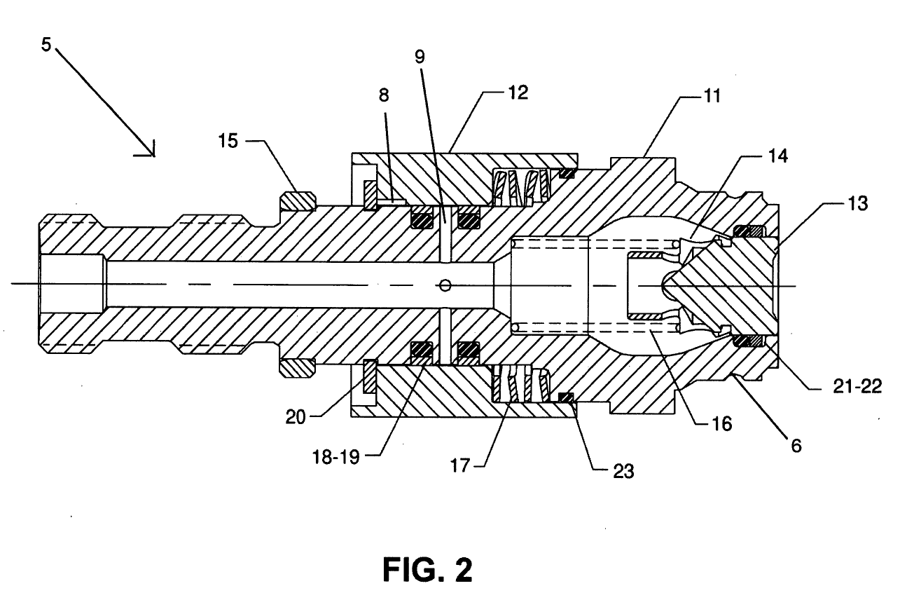

Referring to the accompanying drawings, it will be seen that the quick-disconnect of the preferred embodiment comprises a nipple 5 and a coupler 10 which are designed to mate together as shown in FIG. 1. As best shown in FIG. 2, the nipple 5 comprises a body 11 upon which there resides a pressure relief slide or sleeve 12 and within which there resides a poppet 13. Also within the body 11 is a poppet retainer 14 and a compression spring 16. Slide 12 also engages a compression spring 17 which resides between the radial surface of body 11 and the inside surface of the slide. Other components of nipple 5 include a bushing 15, a retainer ring 20 and a plurality of o-rings 18, 19 and 21-23. A particularly novel aspect of the nipple 5 is the radially directed orifice 9 which exits at and is normally covered by slide 13, in which there is a drilled escape hole 8 where the slide normally bears against retainer ring 20. Nipple 5 also has a ball groove 6.

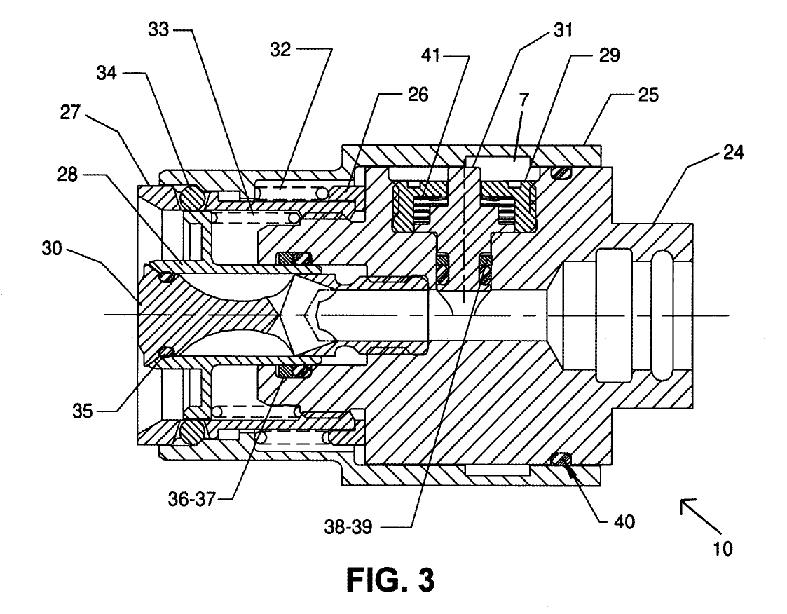

Referring to FIG. 3, it will be seen that coupler 10 comprises a body 24 having a disconnect slide 25 in which there is an internal radial groove 7. Slide 25 bears against compression spring 32. Coupler 10 also comprises a retainer spring 26, a cage 27, a poppet 28, a stem 30, a second compression spring 33 and a plurality of radially displaceable balls 34. Coupler 10 also has a plurality of o-rings 35-40.

Of particular novelty herein within coupler 10 is a lock piston 31 having a cap 29 and a bias wave spring 41. Lock piston 31 responds to pressure in the quick-disconnect to extend into radial groove 7 to prevent movement of slide 15 and thereby prevent disconnection of the coupler 10 from the nipple 5 as will be explained further hereinafter.

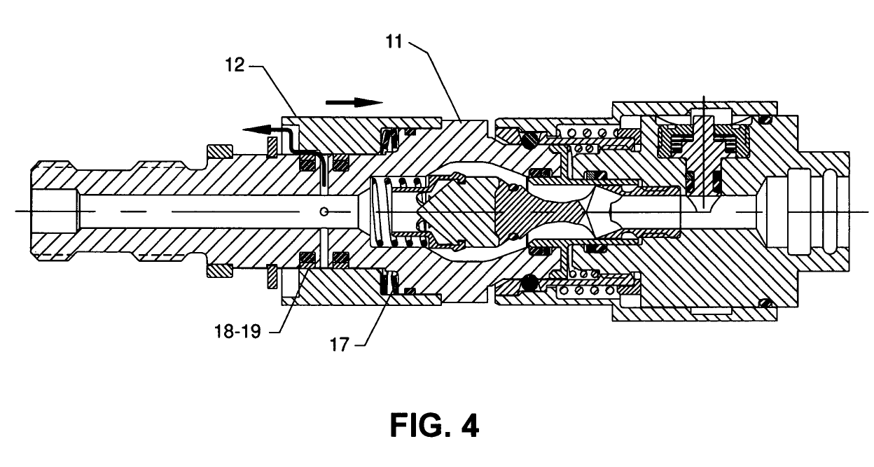

The nipple sleeve 12 is pulled to the open position allowing the residual pressure to escape through orifice 9 which bypasses the internal sealing rings, the bias wave spring 17 which will return the slide to the closed position and internal sealing rings which seal the escape orifice 9 when the slide 12 is closed. The rings also allow low friction movement of the slide. More specifically, the internal relief passage 12 is opened by pulling the sleeve, by hand, compressing the wave spring until the sleeve contacts the body 11 of the nipple 5. The sleeve 12 contains a drilled hole 8 which when closed is outside the ring, therefore sealing it from four holes drilled through the body of the nipple connecting the internal cavity of the nipple with an area outside the body but sealed on either side with the rings. When the sleeve is pulled open, the hole in the sleeve is moved over one of the rings and into the area between the rings and therefore in the area with which the four holes in the body make contact as shown in FIG. 4. The wave spring will drive the sleeve back to the closed position.

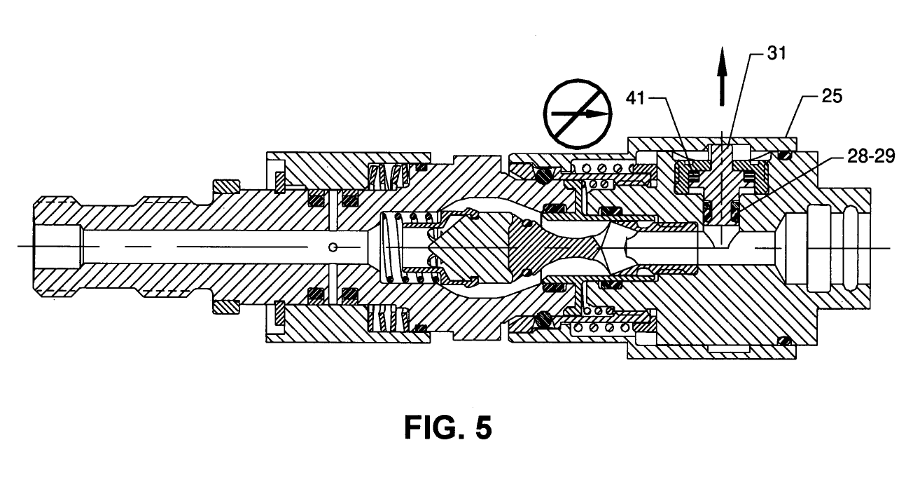

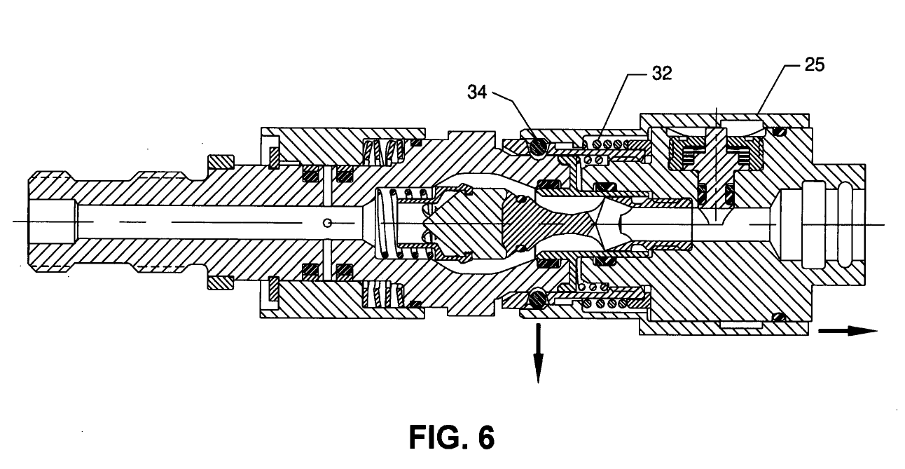

The coupler lock piston 31 is pushed open when the system is under pressure as shown in FIG. 5. Connect/disconnect sleeve 25 with an internal groove 7 into which the lock piston drives and a bias wave spring 41 which will return the piston to the unlocked position when pressure is removed. The piston has an o-ring 28 and backup ring 29 which seal the piston. The coupler contains the sleeve 25 which will be utilized when the nipple and coupler are connected or disconnected. The sleeve 25 is pulled back against a compression spring 32 allowing a plurality of balls 34 to move radially so the coupler can be connected to the nipple. The balls are initially pushed in the radial direction to allow the nipple to move inside the coupler. This movement opens up internal passageways allowing flow though the quick-disconnect. When the nipple reaches a certain position, the balls lock into groove 6 on the nipple. The coupler sleeve will then slid over the balls to prevent any radial movement, thus locking the coupler and nipple. The sleeve is held in this position with the compression spring. To uncouple the coupler and nipple, the sleeve must be pulled back against the compression spring to allow the balls to move radially. The nipple is pushed out of the coupler with a second compression spring 33, which also pushes the balls 34 out of the groove 6 in the nipple body (see FIG. 6). The sleeve contains a groove 7, which sits above the lock piston 31 when the coupler and nipple are connected. When pressure is supplied to the quick-disconnect, the lock piston is pushed up compressing bias wave spring 41, and into the groove 7 in the sleeve. The piston will stay in this position until pressure is removed. The sleeve is now locked in position. Any attempt to uncouple the coupler and nipple by moving the sleeve will drive the sleeve into the lock piston, thus stopping the movement of the sleeve. When pressure is removed, the bias wave spring will drive the lock piston out of the groove in the sleeve and into the unlock position as shown in FIG. 6. The sleeve is now free to move and uncouple the quick-disconnect. Consequently, one novel feature of the present invention is the lock which will not allow the unsafe uncoupling of the quick-disconnect while it is under pressure.

Thus unlike prior art quick-disconnects, the quick-disconnect of the present invention provides a nipple having a unique pressure relief slide that opens an orifice to release pressure and a coupler which provides a radially directed lock piston which prevents de-coupling of the nipple and coupler until pressure is relieved within the quick-disconnect.

It will now be understood that while a preferred embodiment has been disclosed herein, various modifications and additions may be readily made to the illustrated version of the invention. By way of example, the precise level of pressure at which the piston lock no longer locks the connectors together may be selected by changing the resistance of the bias wave spring. Accordingly, the scope hereof shall be limited only by the appended claims and their equivalents.

I claim:

1. In a quick-disconnect connector having a male annular connector and a female annular connector, each configured for axially engaging the other for forming a continuous fluid passage between two hoses when the male and female connectors are engaged and for forming sealed terminations in said hoses when said male and female connectors are disengaged; the improvement comprising:
a pressure relief sleeve slidably positioned on at least one of said male and female connectors; and
an orifice selectively opened and closed by said relief sleeve for allowing fluid under pressure in said connectors to be released while said connectors are engaged.

2. The improvement recited in claim 1 further comprising a locking mechanism in at least one of said male and female connectors, said locking mechanism being responsive to fluid pressure within said engaged connectors to prevent disengagement of said male connector from said female connector until said fluid under pressure is released.

3. The improvement recited in claim 2 wherein said locking mechanism comprises a spring-biased, radially directed piston.

4. The improvement recited in claim 3 wherein at least one of said male and female connectors comprises a disconnect sleeve positioned on an exterior radial surface of said at least one connector for disengaging said connectors when said disconnect sleeve is axially displaced along said exterior surface; said radially-directed piston engaging said disconnect sleeve for preventing axial displacement thereof under fluid pressure within said engaged connectors.

5. In a quick-disconnect connector having a male annular connector and a female annular connector, each configured for axially engaging the other for forming a continuous fluid passage between two hoses when the male and female connectors are engaged and for forming sealed terminations in said hoses when said male and female connectors are disengaged; the improvement comprising:
a locking mechanism in at least one of said male and female connectors, said locking mechanism being responsive to fluid pressure within said engaged connectors to prevent disengagement of said male connector from said female connector until said fluid under pressure is released.

6. The improvement recited in claim 5 wherein said locking mechanism comprises a spring-biased, radially directed piston.

7. The improvement recited in claim 6 further comprising:
a pressure relief sleeve slidably positioned on at least one of said male and female connectors; and
an orifice selectively opened and closed by said relief sleeve for allowing fluid under pressure in said connectors to be released while said connectors are engaged.

8. The improvement recited in claim 7 wherein at least one of said male and female connectors comprises a disconnect sleeve positioned on an exterior radial surface of said at least one connector for disengaging said connectors when said disconnect sleeve is axially displaced along said exterior surface; said radially-directed piston engaging said disconnect sleeve for preventing axial displacement thereof under fluid pressure within said engaged connectors.
